(19) United States
(12) Patent Application Publication
(10) Pub. No.: US 2022/0242036 A1
(43) Pub. Date: Aug. 4, 2022

(54) SYSTEMS AND METHODS FOR FORMING MONOLITHIC ELECTRON MICROSCOPE COMPONENTS

(71) Applicant: NUtech Ventures, Lincoln, NE (US)

(72) Inventors: Herman Batelaan, Lincoln, NE (US); Phillip Wiebe, Lincoln, NE (US)

(21) Appl. No.: 17/724,656

(22) Filed: Apr. 20, 2022

Related U.S. Application Data
(63) Continuation of application No. 16/290,194, filed on Mar. 1, 2019, now abandoned.
(60) Provisional application No. 62/636,940, filed on Mar. 1, 2018.

(51) Int. Cl. B29C 64/118; B33Y 10/00; B33Y 70/00; B33Y 80/00; B29D 11/00

(52) U.S. Cl. CPC B29C 64/118; B33Y 10/00; B29K 2067/046; B33Y 80/00; B29D 11/0074; B33Y 70/00

(57) ABSTRACT

A method of forming a monolithic electron optics component includes providing a dual-nozzle printing head having first and second printing nozzles, heating the dual-nozzle printing head to a desired temperature so that both the first nozzle and the second nozzle are heated to substantially the same, desired temperature, extruding a non-conductive filament material through the first nozzle, and withdrawing a conductive filament material through the second nozzle to form a device component. The desired temperature is typically above a melting temperature of the conductive filament material, above the melting temperature of the non-conducting filament material and lower than the temperature at which the printed device component or object sags under its own weight after printing and bleeding of the non-conducting filament material over the conducting filament material occurs.

### CROSS REFERENCES

This Application is a continuation of U.S. patent application Ser. No. 16/290,194, filed Mar. 1, 2019, which claims priority to U.S. Provisional Patent Application No. 62/636,940, by Batelaan et al., entitled “SYSTEMS AND METHODS FOR FORMING MONOLITHIC ELECTRON MICROSCOPE COMPONENTS,” filed Mar. 1, 2018, both of which are incorporated in their entirety herein by reference.

### FEDERALLY SPONSORED RESEARCH OR DEVELOPMENT

This invention was made with government support under Grant Number 1602755 awarded by the National Science Foundation. The government has certain rights in the invention.

### BACKGROUND

Embodiments of the present invention relate to systems and methods for forming monolithic components for use in systems such as electron microscope systems.

Often in electron optics it is both time consuming and costly to machine complex electron optical elements (such as einzel lenses and deflectors). This leads to electron microscopes and dedicated matter optics experiments to be comparatively expensive. It is therefore desirable to create a fast and cost-effective production method for such components. It is also desirable for these components to be monolithic constructions to avoid the need for assembly.

### SUMMARY

According to an embodiment, a three-dimensional (3-D) printer is used for making electron microscope optics components, and other components for other electromagnetic-based systems. 3-D printing technologies advantageously enable printing with both conducting and insulating materials; conductive materials are used to create required electric potentials, and insulating materials are used to keep the elements electrically isolated.

According to an embodiment, a method of forming a monolithic electron optics component is provided. The method includes providing a dual-nozzle printing head having first and second printing nozzles, heating the dual-nozzle printing head to a desired temperature so that both the first nozzle and the second nozzle are heated to substantially the same, desired temperature, extruding a non-conductive filament material through the first nozzle, and withdrawing a conductive filament material through the second nozzle to form a device component. The desired temperature is typically above a melting temperature of the conductive filament material, above the melting temperature of the non-conducting filament material and lower than the temperature at which the printed device component or object sags under its own weight after printing and bleeding of the non-conducting filament material over the conducting filament material occurs.

According to another embodiment, a non-transitory, computer-readable medium is provided that has or stores instructions thereon which, upon execution by one or more processors, alone or in combination, provide for execution of the method of forming a monolithic electron optics component by controlling a 3-D printer having a dual-nozzle printing head including a first printing nozzle and a second printing nozzle.

### BRIEF DESCRIPTION OF THE DRAWINGS

Embodiments of the present invention will be described in greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a front view of an example of 3-D printer including a dual-headed nozzle according to an embodiment.

FIG. 2A and FIG. 2B show examples of 3-D printed components according to an embodiment.

FIG. 3 shows fabricated deflector and quadrupole device components installed in a vacuum chamber and arranged into a simple electron optics setup.

FIG. 4A and FIG. 4B show a demonstration of the functionality of a deflector element made according to an embodiment, with the letter N written on a fluorescent screen of the electron optics setup of FIG. 3.

FIG. 5 illustrates a method of forming a monolithic electron optics component according to an embodiment.

### DETAILED DESCRIPTION

According to certain embodiments, monolithic electron optics components, such as an electron deflector, an electrostatic quadrupole lens, a focusing lens, such as a three element cylindrical focusing lens, and other components may be formed using 3-D printing technologies as described herein. In certain aspects, printing is done using a dual-headed nozzle to enable switching between printing with a conducting filament material and printing with a non-conductive filament material, or printing simultaneously with both a conducting filament and a non-conductive filament.

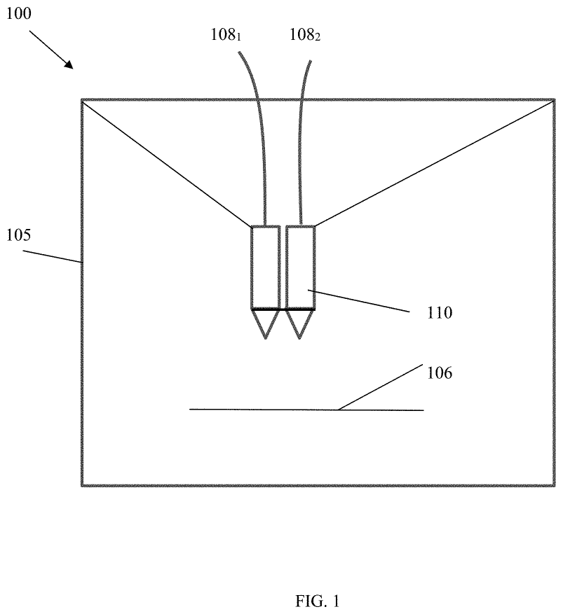

FIG. 1 illustrates an example 3-D printer 100 including a dual-nozzle printing head 110 according to an embodiment. As shown, printer 100 may include a box frame structure 105 for holding the various printer system components and allowing the dual-nozzle printing head 110 to be moved in relation to a print bed 106. As shown, filament lines 1081 and 1082 are fed into receiving ends of each nozzle of the printing head 110 where the filament material(s) may be heated and pushed out or extruded through the nozzle tips. A controller (e.g., one or more processors, not shown) controls a motor (not shown, e.g., including a stepper motor, belt motor, or threaded screws) to move the print nozzle 110 in 3-dimensions in relation to the print bed 106 and print with the filament materials to form a device according to an object model (e.g., stereolithography or STL file) stored in a controller memory and/or fed to the controller from an external memory. The dual-nozzle printing head may include a single heating block coupled with both nozzles, or it may have separate heating blocks, each couple with one of the nozzles. The controller also controls operation of the heating block(s) and other system components, based on program code including instructions for controlling system components based on the object model.

An example of a useful dual-nozzle printing head is a LULZBOT TAZ 6 printer with a dual extruder tool-head (v2). An example of a useful conducting filament is Proto-Pasta PLA conductive CDP 12805, and an example of a useful non-conductive filament is Proto-Pasta Everyday PLA. Outgassing of these printing materials, e.g., when used for electron microscope system components or other electron optics system components, is advantageously sufficiently small so as to maintain the system's vacuum quality. One skilled in the art will recognize other useful conductive and non-conductive printing materials for use with a 3-D printer.

One of the principle limitations is the scale/size of the printed objects. This is due, in part, to the intrinsic structural fragility of the filament material(s) and printing resolution of the printer. Another limiting factor of these monolithic devices is the conductive material's tendency to bleed over the nonconductive material, which tends to defeat the electrical isolation of the device. This is due to the way the printing material is deposited and shaped. The solid Polylactic Acid (PLA) filament material is heated and melted while being pushed through an extruding nozzle in a liquid state, and then cools back into solid form on a platform (e.g., print bed 106). While conductive PLA has a different melting point than the nonconductive PLA, both printing nozzles in the dual-nozzle printing head are heated to the same temperature. One solution to this is to set the printer head to above the higher melting point of the two materials. However, if the printing temperature is too high then the conductive filament may begin to leak through its nozzle even if it is shut off. Additionally, if the filament is too hot then the material may begin to expand. Therefore, there is a narrow range of tolerated temperature for the printing to function correctly, and the printer is operated to withdraw the conductive filament while not being extruded. For example, for PLA, the operating temperature may be between about 205° C. and about 210° C. Various nozzle tip diameters also provide optimized resolution and help avoid the aforementioned problems. In certain embodiments, the nozzle diameter may be between about 1.0 mm and 1.5 mm. For example, a standard nozzle size of 1.5 mm resulted in bleeding. The use of a nozzle of 1.2 mm solved this problem for the particular materials used. It should be appreciated that other nozzle tip diameters may be used depending on the particular filament material used. Finally, cooling of the deposited material needs to be considered to avoid the situation that the printed objects after printing may deform under the pressure of their own weight. A fan may be used during the printing process to provide sufficient cooling.

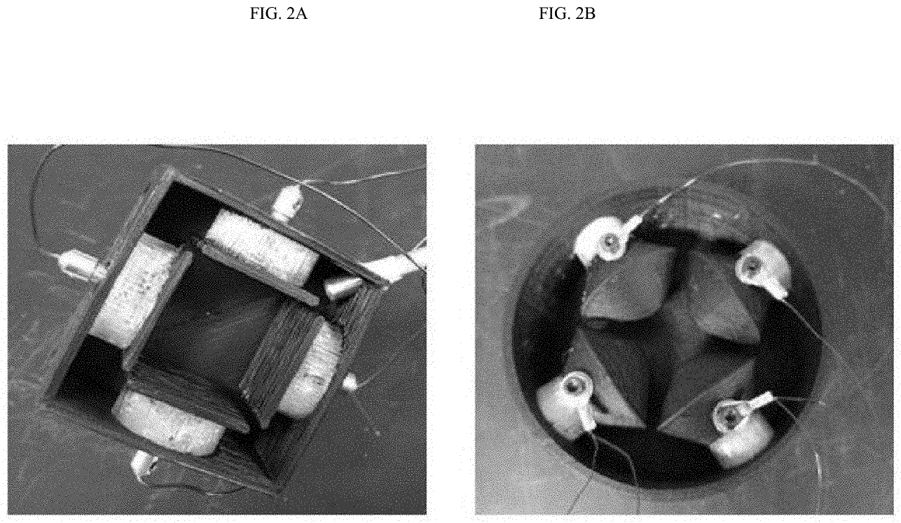

According to certain embodiments, an electron deflector (which can steer the electron beam in both transverse dimensions) and an electrostatic quadrupole lens (with a hyperbola design) were made according to the methods herein. An example of a 3-D printed electron deflector component is shown in FIG. 2A and an example of a 3-D printed electron quadrupole lens component is shown in FIG. 2B. The plates and hyperbolas were checked and confirmed to be insulated from their housing, and the final resistance (˜10 kΩ) was such that a constant potential could be defined. These components were mounted to vacuum feedthroughs.

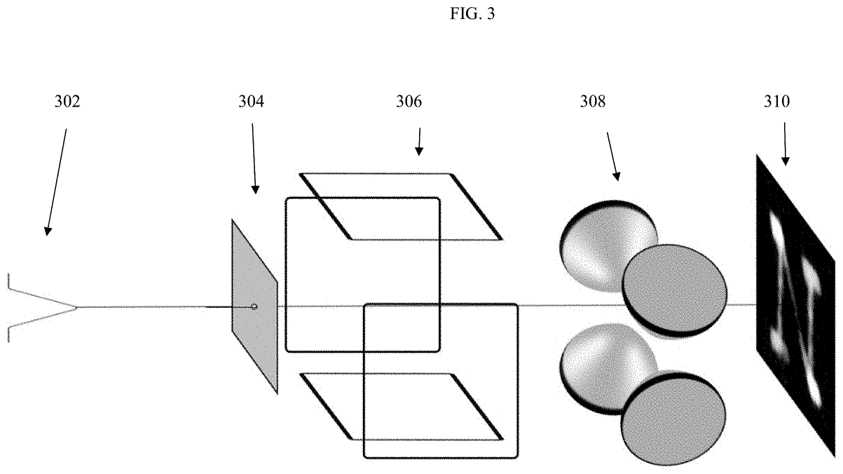

To test these fabricated device components, the deflector and quadrupole lens were installed in a vacuum chamber and arranged into a simple electron optics setup as shown in FIG. 3. A 100 eV electron beam was emitted from a tungsten filament cathode 302 (e.g., Kimball Physics ES-026R) with a Wehnelt cylinder to enhance the forward transmission, producing an initial emission current of 1.6 μA. A collimating aperture 304 (e.g., ˜200 μm collimation aperture) was placed 32.5 cm downstream. The electrons first pass through 3 cm long pairs of deflection plates of the deflector 306 and after another 27 cm pass through the electric quadrupole lens 308 and are detected with a chevron multichannel plate (MCP) 310 and phosphorous screen (e.g., BVS-1-OPT01), which is imaged with a CCD camera and image acquisition software (not shown).

The complete testing rig was placed in a regular high vacuum chamber and pumped down with a turbo and roughing pump. With the printed elements installed, their outgassing was limited so that the vacuum system was able to pump down to a final pressure of 10′ Torr. This implies that the mean free path of the electrons is ˜6.9 m. Considering that the entire path length is only ˜0.60 m, this implies that the electron beam is unimpeded and the 3-D printed plastic electron optics elements do not outgas to a detrimental degree.

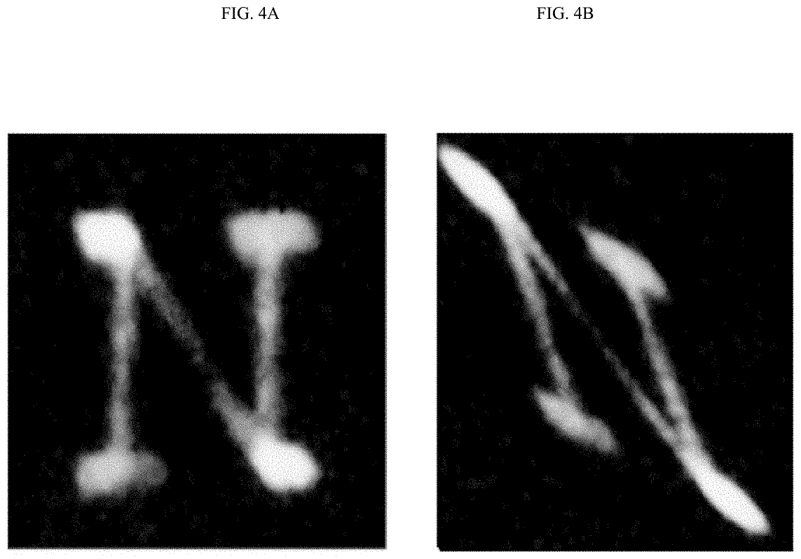

When observing the electron beam with the MCP, the imaged beam spot maintained its narrowness with time. This indicates that there is no appreciable charging taking place in the system. To demonstrate the functionality of the deflector element, the letter N was written on the fluorescent screen using a manually programmed master-slave pair of SRS function generators running at 10 kHz as shown in FIG. 4A. The constant voltage difference ΔV on the deflection plates causes a deflection is h={(ed)/(mv²)}ΔV; where e is the electron's charge, d is the distance from the deflection plate to the phosphorous screen, m is the electron's mass and v is the electron's velocity. From the observed deflection of ˜3.1 mm, it is expected that the deflection plate holds a voltage difference of ΔV=4.1V, which is close to the applied voltage of ΔV_{A}=4.4V.

To test the effectiveness of the quadrupole lens, voltages differences of about ±1 V were applied to the set of diagonal hyperbolic electrodes of the quadrupole lens, while the deflector plates were scanning. The result was that the “N” at the detector was stretched along the positively-biased diagonal, and compressed along the negatively biased diagonal as shown in FIG. 4B. A rough estimate of the degree of expected spatial distortion can be computed from

$$S ≡ \frac{{M}_{e}}{{M}_{c}} = \frac{1 + Δ}{1 - Δ} ,$$

where the squeezing factor S is defined as the ratio between the magnification factor in the elongation direction Mₑ over the magnification factor in the compression direction M_{c} and Δ=eV₀l₁l₂L/(r₀²E(l₁+l₂)). This result can be obtained from applying the impulse approximation and assuming a uniform saddlepoint potential over the length of the quadrupole. The applied voltage difference V₀ is about 1V, the quadrupole length L is 0.04 m, the electrode distance 2r₀ is 20 mm, the electron energy E is 100 eV, the distance from the deflection plates to the quadrupole l₁ is 0.3 m and from the quadrupole to the detector l₂ is 0.3 m and the electron charge is given by e. The measured values for the image are Mₑ=1.45 and M_{c}=1.70, giving S=2.5. The estimated theoretical value S=4. Given the crude approximation does indicate that the order of magnitude of the experimental design is correct.

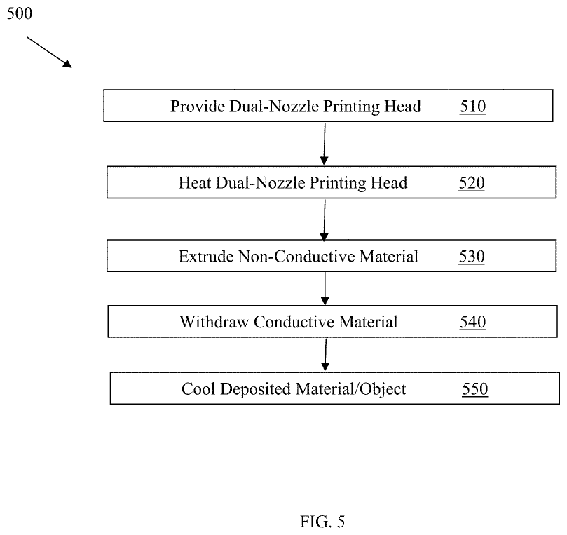

FIG. 5 illustrates a method 500 of forming a monolithic electron optics component according to an embodiment. The method 500 includes providing a dual-nozzle printing head at step 510. The dual-nozzle printing head includes first and second printing nozzles. In step 520, the dual-nozzle printing head is heated to a desired temperature so that both the first nozzle and the second nozzle are heated to substantially the same, desired temperature. For example, the dual-nozzle printing head may have a single heating block coupled with both nozzles, or it may have separate heating blocks, each couple with one of the nozzles. In step 530, a non-conductive filament material is extruded through the first nozzle, and in step 540 a conductive filament material is withdrawn through the second nozzle. Step 530 and 540 are performed in response to control signals from a control device to form a device component according to an object model, and may be performed in any order as defined by the object model. In certain aspects, the desired temperature is above a melting temperature of the conductive filament material, above the melting temperature of the non-conducting filament material and lower than the temperature at which the printed device component or object would sag under its own weight after printing and bleeding of the non-conducting filament material over the conducting filament material occurs. In step 550, the deposited material and/or printed object may be cooled, e.g., cooling may be continuous through the steps 530 and/or 540 or may occur at discrete time(s) and/or at the end of the object formation process, as needed.

Advantageously, functioning electron optical components can be, and have been, successfully produced with a commercial 3-D printer with a dual-nozzle printing head according to embodiments. Such methods provide a tangible step toward developing an affordable electron microscope or other electron optics systems that could become more cost effective and readily accessible to larger group, including for example high schools.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Certain embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, the claimed embodiments include all modifications and equivalents of the subject matter recited in the claims appended hereto as permitted by applicable law. Moreover, any combination of the above-described elements in all possible variations thereof is encompassed by embodiments unless otherwise indicated herein or otherwise clearly contradicted by context.

1. A monolithic electron optics component, for use in a vacuum environment in an electron microscope system, wherein the component includes a monolithic structure including a first non-conductive material and a second conductive material, wherein the first non-conductive material and the second conductive material each comprises a polylactic acid (PLA).

2. The monolithic electron optics component according to claim 1, wherein the component is an electrostatic quadrupole lens element.

3. The monolithic electron optics component according to claim 1, wherein the component is an electron beam deflector element.

4. The monolithic electron optics component according to claim 1, wherein the component is a focusing lens element.

5. The monolithic electron optics component according to claim 4, wherein the focusing lens element is a cylindrical focusing lens element.

6. An electron microscope system, comprising:
a vacuum chamber structure configured to provide a vacuum pressure environment for elements housed within the vacuum chamber structure;
an electron beam source configured to emit an electron beam;
at least one monolithic electron optics component housed in the vacuum chamber structure and positioned in a path of the electron beam, wherein the at least one monolithic electron optics component is configured to deflect or guide the electron beam; and
a detection element positioned in the path of the electron beam; and
wherein the at least one monolithic electron optics component includes a monolithic structure including a first non-conductive material and a second conductive material, wherein the first non-conductive material and the second conductive material each comprises a polylactic acid (PLA).

7. The system of claim 6, wherein the at least one monolithic electron optics component includes a monolithic electron deflector element comprising two pairs of deflection plates configured to deflect the electron beam in response to voltage differences applied to each of the two pairs of plates.

8. The system of claim 6, wherein the at least one monolithic electron optics component includes a monolithic electrostatic quadrupole lens element configured to guide the electron beam in response to voltage difference applied to electrodes of the quadrupole lens.

9. The system of claim 6, wherein the at least one monolithic electron optics component includes both a monolithic electron deflector element comprising two pairs of deflection plates, and a monolithic electrostatic quadrupole lens element.

10. The system of claim 6, wherein the vacuum pressure environment includes a pressure of 10⁻⁶ Torr.
